(19) United States
(12) Patent Application Publication
(10) Pub. No.: US 2014/0365727 A1
(43) Pub. Date: Dec. 11, 2014

(54) STORAGE CONTROL DEVICE AND ACCESS CONTROL METHOD

(71) Applicant: FUJITSU LIMITED, Kawasaki-shi (JP)

(72) Inventors: Hidekazu KAWANO, Saitama (JP); Hajime Watanabe, Hadano (JP); Jun Ishizaki, Sagamihara (JP); Hiroshi Chiba, Chigasaki (JP); Nobukazu Kirigaya, Kawasaki (JP); Yoshiharu Itoh, Shinagawa (JP); Hiroshi Ichikawa, Kawasaki (JP)

(73) Assignee: FUJITSU LIMITED, Kawasaki-shi (JP)

(21) Appl. No.: 14/251,737

(22) Filed: Apr. 14, 2014

(30) Foreign Application Priority Data
Jun. 10, 2013 (JP) 2013-121983

(51) Int. Cl. G06F 12/14; G06F 3/06

(52) U.S. Cl. CPC G06F 12/1458; G06F 3/0604; G06F 3/0659; G06F 3/0653; G06F 3/0689; G06F 2003/0692
USPC 711/114; 711/163

(57) ABSTRACT

A storage control device includes a processor. The processor is configured to receive commands requesting access to a first storage. The processor is configured to detect, among the received commands, a monitoring command requesting access for monitoring to the first storage. The processor is configured to restrict access to the first storage in response to the detected monitoring command.

### CROSS-REFERENCE TO RELATED APPLICATION

This application is based upon and claims the benefit of priority of the prior Japanese Patent Application No. 2013-121983, filed on Jun. 10, 2013, the entire contents of which are incorporated herein by reference.

### FIELD

The embodiments discussed herein are related to a storage control device and an access control method.

### BACKGROUND

The amount of data to be processed by information processing devices such as computers is increasing. Currently, information processing devices typically process a very large amount of data. If a large amount of data is processed, the cost used for storing data is also very large. In view of this, storage tiering, which enables fast access to data while reducing data storage costs, is adopted in many cases.

In an information processing device, data to be used or data that is more likely to be used is stored in a main storage device, and data that is less likely to be used is stored in a slower storage. A hard disk drive (HDD) is broadly adopted as such a storage that is slower than the main storage device. Hereinafter, in order to avoid confusion, an HDD is assumed to be such a slower storage.

Access to an HDD is performed by executing basic software (hereinafter referred to as an “OS”, which stands for an operating system). By executing a certain OS, an information processing device may issue commands intended for path monitoring, device monitoring, file-system monitoring, and so on, to access an HDD. Hereinafter, a command issued for access to an HDD for monitoring is referred to as a “monitoring command”.

The monitoring command is not a command (hereinafter referred to as a “user command”) for data processing that is to be originally performed by an information processing device. An issued monitoring command causes consumption of resources for access to an HDD. For this reason, an issued monitoring command may reduce the amount of resources available to a user command, thereby decreasing the access speed of an HDD. In a situation where an HDD is in a busy state, an issued monitoring command surely decreases the access speed of the HDD.

A low-power-consumption function is provided in many cases for a storage such as an HDD. The low-power-consumption function is a function that stops rotation of a hard disk, for example, when access is not performed for a certain period of time, to reduce power consumption.

A monitoring command is issued separately from a user command. Issuance of a monitoring command causes access to an HDD to be performed. For this reason, issuance of a monitoring command inhibits transition from a normal mode to a low-power-consumption mode in which the low-power-consumption function is effective, and promotes, during the low-power-consumption mode, transition to the normal mode. From such a fact, an issued monitoring command practically reduces the low-power-consumption function.

The decrease in the access speed and the reduction in the low-power-consumption function of an HDD each correspond to a reduction in the operating performance of the HDD. Therefore, it is considered important to suppress the reduction in the operating performance of an HDD caused by issuance of a monitoring command. This also applies to storages other than the HDD.

Related techniques are disclosed in, for example, Japanese Laid-open Patent Publication No. 2008-310741 and Japanese Laid-open Patent Publication No. 2010-198464.

### SUMMARY

According to an aspect of the present invention, provided is a storage control device including a processor. The processor is configured to receive commands requesting access to a first storage. The processor is configured to detect, among the received commands, a monitoring command requesting access for monitoring to the first storage. The processor is configured to restrict access to the first storage in response to the detected monitoring command.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of a disk array device in which a storage control device according to an embodiment is installed;

FIG. 2 is a diagram for explaining a storage device determined as an access destination of access in response to a monitoring I/O;

FIG. 3 is a diagram illustrating an exemplary configuration of a history table;

FIG. 4 is a diagram illustrating an exemplary configuration of a monitoring target table;

FIG. 5 is a diagram illustrating an exemplary configuration of a CM, which is a storage control device according to an embodiment;

FIG. 6 is a flowchart of access destination determination processing;

FIG. 7 is a flowchart of command processing;

FIG. 8 is a flowchart of monitoring I/O detection processing;

FIG. 9 is a flowchart of normal operation processing; and

FIG. 10 is a flowchart of low-power-consumption operation processing.

### DESCRIPTION OF EMBODIMENTS

Hereinafter, embodiments of the present disclosure will be described in detail with reference to the accompanying drawings.

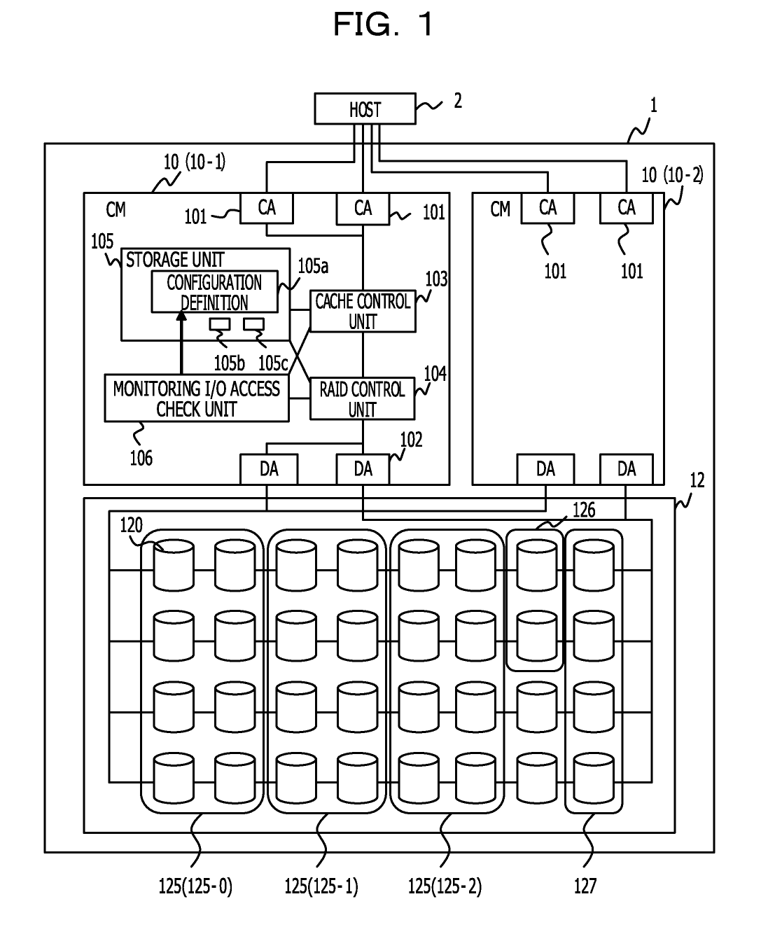

FIG. 1 is a diagram illustrating an exemplary functional configuration of a disk array device in which a storage control device according to an embodiment is installed.

As illustrated in FIG. 1, a disk array device 1 is provided in order to offer data that is used for data processing by a host computer (hereinafter abbreviated as a “host”) 2. In the disk array device 1, two control modules (CMs) 10 (10-1 and 10-2), and an HDD group 12 having a plurality of HDDs 120 are installed. The storage control device according to the present embodiment is implemented as the CMs 10.

In the HDD group 12, a plurality of redundant arrays of inexpensive disks (RAID) groups 125 (125-0 to 125-2) are constructed. A group 126 is a group assigned to the CMs 10, and system files are stored in the HDDs 120 belonging to the group 126. A group 127 is a group, which is a set of the HDDs 120 used as hot spares of the RAID groups 125.

Note that while the HDDs 120 constituting the group 126 are assigned from among the HDDs 120 constituting the HDD group 12, this is not a requirement. That is, the HDDs 120 constituting the group 126 may be installed in the disk array device 1 separately from the HDD group 12.

Each CM 10 is a control device that processes a command received from the host 2 and accesses the HDD group 12. Each CM 10 includes two channel adaptors (CAs) 101, two device adaptors (DA) 102, a cache control unit 103, a RAID control unit 104, a storage unit 105, and a monitoring input/output (I/O) access check unit 106.

The two CAs 101 are interfaces that enable communication with the host 2. A command received by each CA 101 from the host 2 is output to the cache control unit 103. Each CA 101 sends data input from the cache control unit 103 to the host 2.

The two DAs 102 are interfaces for performing communication with the HDDs 120 constituting the HDD group 12. Each DA 102 is controlled by the RAID control unit 104.

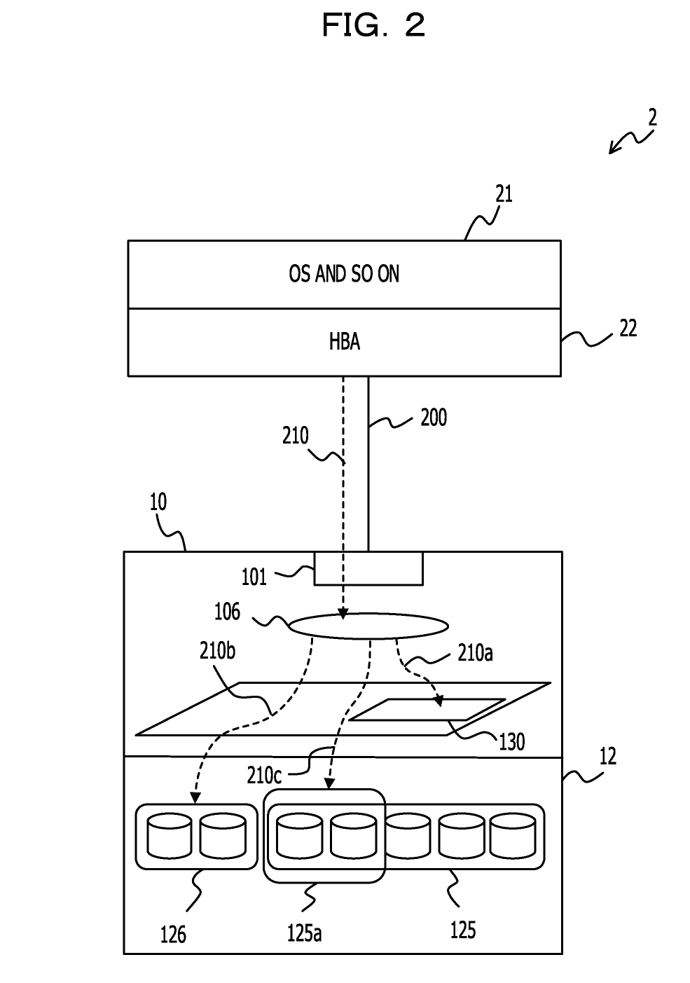

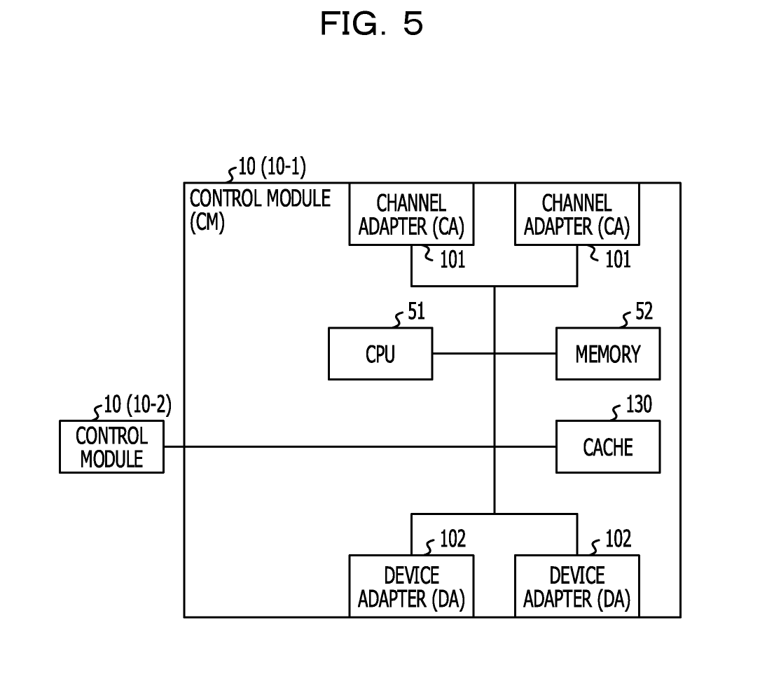

The cache control unit 103 manages a cache memory (hereinafter abbreviated as a “cache”) 130 illustrated in FIG. 2 and FIG. 5. In the cache 130, data received, together with a command, from the host 2, data read from the HDD group 12, and so on are stored. If data requested by a read command received from the host 2 exists in the cache 130, the cache control unit 103 reads requested data from the cache 130 and sends the read data through the CA 101 to the host 2. If data requested by the read command does not exist in the cache 130, the cache control unit 103 outputs the read command to the RAID control unit 104.

The RAID control unit 104 processes a command input from the cache control unit 103. If the command is a command requesting access to some HDD 120, the RAID control unit 104 performs, through the DA 102, access to the HDD 120 to which the command requests to access.

Construction of a RAID group 125 may be performed in accordance with a command received from the host 2. In accordance with the command, the RAID control unit 104 determines a combination of the HDDs 120 constituting the RAID group 125.

In the storage unit 105, configuration definition information 105a, a history table 105b, and a monitoring target table 105c are saved.

The configuration definition information 105a includes, for every RAID group 125, configuration information indicating the combination of the HDDs 120 constituting the RAID group 125, setting information thereof, management information of data checking, and so on. The RAID control unit 104 updates the configuration definition information 105a if the RAID group 125 is newly constructed or the combination of the HDDs 120 constituting the existing RAID group 125 is changed in accordance with a command sent from the host 2.

The monitoring I/O access check unit 106 identifies a command (hereinafter referred to as a “monitoring I/O”) requesting access to the HDD 120, which is issued from the host 2 for the purpose of path monitoring, device monitoring, file system monitoring, and so on. The history table 105b saved in the storage unit 105 is used for identification of a monitoring I/O. The monitoring target table 105c is used for storing information indicating the identified monitoring I/O.

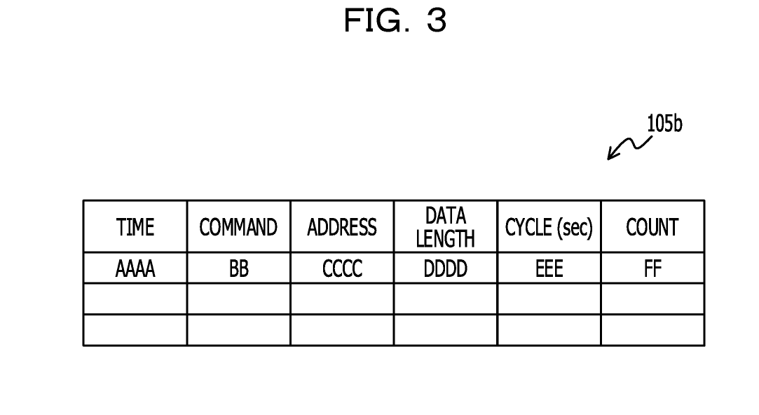

FIG. 3 illustrates an exemplary configuration of a history table. As illustrated in FIG. 3, in the history table 105b, respective data of the reception date and time (denoted as “TIME” in FIG. 3), the command type (denoted as “COMMAND” in FIG. 3), the address to which access is requested (denoted as “ADDRESS” in FIG. 3), the data length of data for which access is requested (denoted as “DATA LENGTH” in FIG. 3), the cycle (the reception interval, denoted as “CYCLE” in FIG. 3), and the number of receptions (denoted as “COUNT” in FIG. 3) are stored for every command received from the host 2.

Generally, the monitoring I/O includes both a read command and a write command. The intervals at which the host 2 executing one OS issues the same type of monitoring I/Os are often fixed, the addresses to which the monitoring I/Os request to access, and the data lengths of data for which the monitoring I/Os request to access are often the same. The data length is usually not so large. From this situation, in the present embodiment, commands that satisfy conditions (hereinafter referred to as “command conditions”) that each of the data lengths is equal to or less than a predetermined threshold, and the command types, the addresses, and the data lengths are the same are regarded as candidates for a monitoring I/O. In the present embodiment, among the candidates, candidates with a fixed cycle, that is, reception intervals of the candidates match within a permissible range), is identified as monitoring I/Os.

Even commands (hereinafter referred to as “user commands” for the sake of convenience) other than monitoring I/Os may satisfy the above command conditions. In order to avoid misidentifying user commands as monitoring I/Os, it is desirable that a condition (hereinafter, referred to as a “continuation condition”) is added that commands that satisfy the above command conditions and have the fixed cycle is issued continuously at least five times. In the present embodiment, in order to realize higher accuracy, the continuation condition is that such commands are issued continuously ten times. The number of receptions is data used for counting the number of times the candidates continuously satisfies the continuation condition.

The monitoring I/O access check unit 106 stores, in the history table 105b, various data extracted from a command with the data length equal to or less than the threshold. Referring to the history table 105b, the monitoring I/O access check unit 106 identifies a command (entry) that satisfies the command conditions, and stores (updates) respective data of the cycle and the number of receptions. As a result, the value of the number of receptions is incremented if a command that satisfies the command conditions and has the same cycle is received.

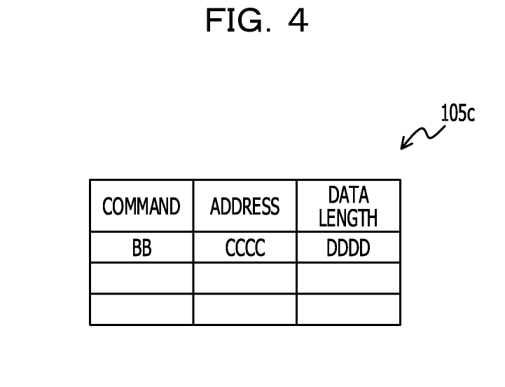

FIG. 4 illustrates an exemplary configuration of a monitoring target table. As illustrated in FIG. 4, in the monitoring target table 105c, respective data of the command type, the address, and the data length are stored for every identified monitoring I/O.

The command type, the address, and the data length are a combination of data that enables a monitoring I/O to be identified. Accordingly, a monitoring I/O sent from the host 2 may be detected by referring to the monitoring target table 105c. The data of these items may be extracted from a command whose number of receptions has reached ten.

FIG. 2 is a diagram for explaining a storage device determined as an access destination of access in response to a monitoring I/O.

In the present embodiment, transition from the normal mode to a low-power-consumption mode, in which the low-power-consumption function is effective, is performed in units of the RAID group 125. In FIG. 2, one RAID group 125 is focused on and an example of a storage device determined as an access destination of access in response to a monitoring I/O 210 is illustrated.

A monitoring I/O causes consumption of resources for access to an HDD 120. For this reason, the monitoring I/O becomes a cause of a decrease in access speed particularly in an HDD 120 in a busy state. In addition, the monitoring I/O may inhibit the low-power-consumption function for reducing the power consumption of an HDD 120 from becoming effective. More particularly, there are possibilities that the low-power-consumption function is not enabled and that the period during which the low-power-consumption function is effective is reduced. The decrease in the access speed and the reduction of the low-power-consumption function both reduce the operating performance of the HDD 120. According to the present embodiment, a storage device different from the HDD 120 specified by a monitoring I/O may be set as an access destination of access in response to the monitoring I/O in order to suppress such a performance reduction.

In the present embodiment, greater importance is attached to reducing the power consumption by deactivating an HDD 120. Therefore, according to the present embodiment, during the low-power-consumption mode in which the low-power-consumption function is effective, the destination of access in response to a monitoring I/O is changed to a storage device that is set in advance.

Note that the destination of access in response to a monitoring I/O may be changed only during the normal mode. The destination of access in response to a monitoring I/O may be changed both during the normal mode and during the low-power-consumption mode. The situation or the period for changing the destination of access in response to a monitoring I/O may be set desirably by the operator. In order to achieve the original purpose of the monitoring I/O, it is desirable to provide a period during which the destination of access in response to the monitoring I/O is not changed.

In the host 2, a program group 21 including an OS, various application programs, and so on is executed. The monitoring I/O 210 is issued, for example, by executing the OS included in the program group 21, and the issued monitoring I/O 210 is sent, for example, through a host bus adapter (HBA) 22 and a physical path 200, such as a network cable, to the disk array device 1.

The monitoring I/O access check unit 106 mentioned above confirms storage devices existing in the disk array device 1, and determines a storage device serving as the access destination of access in response to the monitoring I/O 210. Each of broken-line arrows 210a to 210c drawn in FIG. 2 indicates a storage device determined as the access destination of access in response to the monitoring I/O 210. That is, in the present embodiment, access in response to the monitoring I/O 210 is made to any of the cache 130, an HDD 120 belonging to the group 126, and an HDD 120 constituting a subgroup 125a in the RAID group 125. The subgroup 125a of each RAID group 125 is defined by the configuration definition information 105a.

The cache 130 and the HDD 120 belonging to the group 126 are storage devices different from the HDD 120 belonging to the RAID group 125. Therefore, if it is determined that the destination of access in response to the monitoring I/O 210 is any of them, the decrease in access speed caused by the monitoring I/O 210 in the HDD 120 belonging to the RAID group 125 is avoided. In addition, if the entirety of the RAID group 125 has transitioned to the low-power-consumption mode, returning to the normal mode caused by the monitoring I/O 210 is avoided. As a result, the performance reduction caused by the monitoring I/O 210 may be avoided in the entirety of the RAID group 125.

If it is determined that the destination of access in response to the monitoring I/O 210 is the HDD 120 constituting the subgroup 125a in the RAID group 125, the decrease in access speed caused by the monitoring I/O 210 occurs only in the HDDs 120 of the subgroup 125a. Transition to the low-power-consumption mode may be performed in the HDDs 120 of the RAID group 125 excluding those of the subgroup 125a. Returning from the low-power-consumption mode to the normal mode by the monitoring I/O 210 may also be avoided. As a result, the performance reduction caused by the monitoring I/O 210 may be suppressed in the entirety of the RAID group 125.

FIG. 5 is a diagram illustrating an exemplary configuration of a CM, which is a storage control device according to the present embodiment. Next, an exemplary configuration of the CM 10 will be described in detail with reference to FIG. 5.

The two CMs 10-1 and 10-2 have the same configuration. As illustrated in FIG. 5, The CM 10-1 includes, in addition to the two CAs 101, the two DAs 102, and the cache 130, a central processing unit (CPU) 51 and a memory 52. These components are connected to a bus, and the CM 10-2 is also connected to the bus.

The memory 52 is used as a work memory for the CPU 51. The storage unit 105 illustrated in FIG. 1 corresponds, for example, to the memory 52. The configuration definition information 105a, the history table 105b, and the monitoring target table 105c are also stored, for example, in an HDD 120 constituting the group 126.

In an HDD 120 constituting the group 126, for example, a program (hereinafter referred to as a “control program”) executed by the CPU 51 is also stored. The cache control unit 103, the RAID control unit 104, and the monitoring I/O access check unit 106 are implemented in such a way that the CPU 51 reads the control program from the HDD 120 constituting the group 126 into the memory 52 and executes the control program.

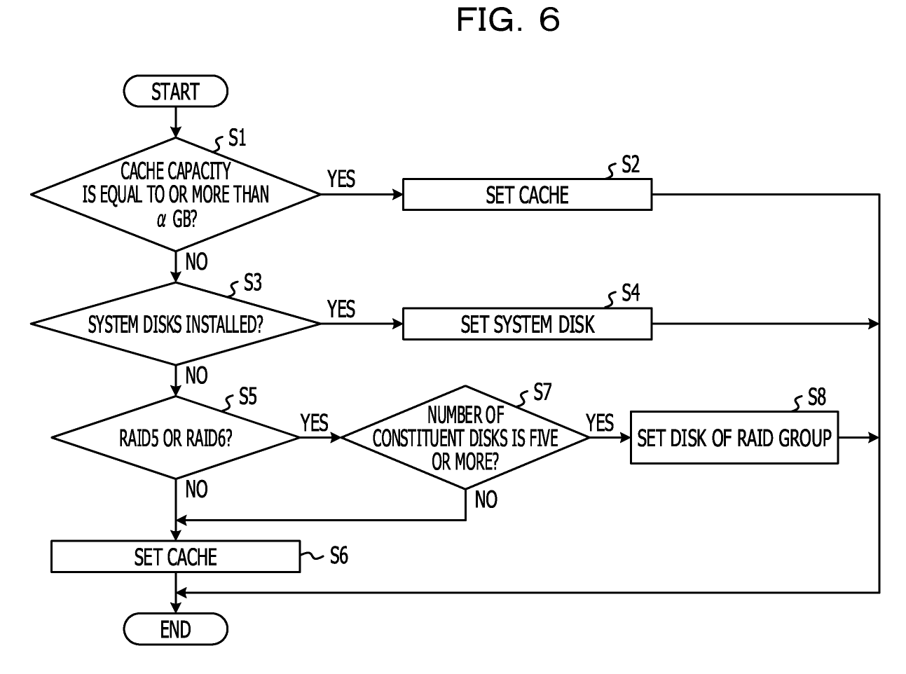

The control program mentioned above includes, as subprograms, a determination program for determining the destination of access in response to the monitoring I/O 210, a processing program for processing a command received from the host 2, and so on. Hereinafter, with reference to various flowcharts illustrated in FIG. 6 to FIG. 10, operations of the CPU 51 caused by execution of the determination program and the processing program will be described in detail.

FIG. 6 is a flowchart of access destination determination processing. The access destination determination processing is processing for determining a destination of access in response to the monitoring I/O 210, and is implemented by the CPU 51 executing the determination program mentioned above.

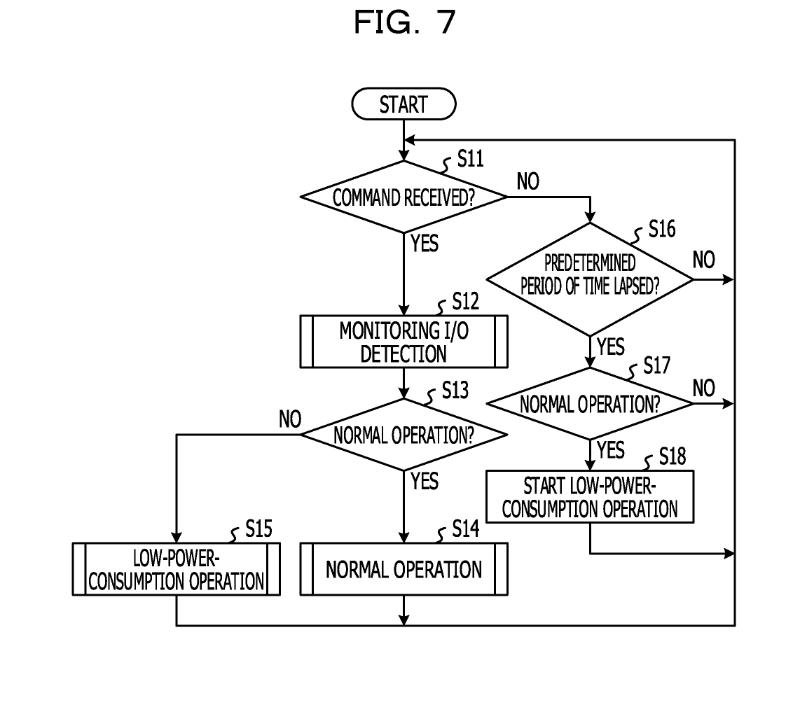

As described above, the determination of the destination of access in response to the monitoring I/O 210 and the mode transition are performed in units of the RAID group 125. In FIG. 6, FIG. 7, and the following drawings, the flowcharts are illustrated, for the sake of convenience, in such a manner that one RAID group 125 is focused. Here, in order to avoid confusion, description is given with attention paid only to one RAID group 125.

It is usually unnecessary to change the destination of access in response to the monitoring I/O 210 unless, for example, replacement of the CM 10, a change in the combination of HDDs 120 constituting the RAID group 125, or the like occurs and the configuration of the disk array device 1 is changed. Accordingly, the access destination determination processing is performed upon activation of the CM 10 or by an instruction of an operator who manages the disk array device 1, or the like.

First, the CPU 51 determines whether the capacity of the cache 130 is equal to or more than α GB (S1). The α is a threshold set for determining whether the cache 130 has a capacity sufficiently large to allow access in response to the monitoring I/O 210. For this reason, if the cache 130 has a sufficiently large capacity, the determination in S1 is Yes (hereinafter abbreviated as “Y”), and the processing proceeds to S2. If the cache 130 does not have a sufficiently large capacity, the determination in S1 is No (hereinafter abbreviated as “N”), and the processing proceeds to S3.

In S2, the CPU 51 sets the cache 130 as the destination of access in response to the monitoring I/O 210. At this point, the CPU 51 determines, in addition, a region to be accessed in the cache 130, for example. Thereafter, the access destination determination processing terminates.

In S3, the CPU 51 determines whether the HDDs (denoted as “SYSTEM DISKS” in FIG. 6) 120 constituting the group 126 are installed. If the HDDs 120 constituting the group 126 exist, the determination in S3 is Y and the processing proceeds to S4. If the HDDs 120 constituting the group 126 do not exist, the determination in S3 is N and the processing proceeds to S5.

In S4, the CPU 51 sets any one of the HDDs 120 constituting the group 126 as the destination of access in response to the monitoring I/O 210. Thereafter, the access destination determination processing terminates.

In S5, the CPU 51 determines whether RAID5 or RAID6 is adopted for the target RAID group 125. If RAID5 or RAID6 is adopted for the target RAID group 125, the determination in S5 is Y and the processing proceeds to S7. If neither RAID5 nor RAID6 is adopted as the target RAID group 125, the determination in S5 is N and the processing proceeds to S6. The specifications including RAID5, RAID6, or the like adopted for the RAID group 125 may be identified based on the configuration definition information 105a.

In S6, the CPU 51 sets the cache 130 as the destination of access in response to the monitoring I/O 210. In addition, at this point, the CPU 51 determines, in addition, a region to be accessed in the cache 130. Thereafter, the access destination determination processing terminates.

In S7, the CPU 51 determines whether the number of the HDDs 120 constituting the target RAID group 125 is five or more. If five or more HDDs 120 belong to the target RAID group 125, the determination in S7 is Y and the processing proceeds to S8. If the number of the HDDs 120 constituting the target RAID group 125 is four or less, the determination in S7 is N and the processing proceeds to S6.

In S8, the CPU 51 sets an HDD 120 of the subgroup 125a constituting the target RAID group 125, as the destination of access in response to the monitoring I/O 210. Thereafter, the access destination determination processing terminates.

In RAID5, failure of one HDD 120 may be handled, and, in RAID6, failure of up to two HDDs 120 may be handled. However, failure results in additional processing for recovery of data. The smaller the number of the HDDs 120 constituting the RAID group 125, the higher the possibility that processing will have to be performed. In the present embodiment, with an intention to suppress a decrease in the access speed involved in processing for recovery of data, the condition that five or more HDDs 120 exist is given as the condition for setting the subgroup 125a of the target RAID group 125 as the access destination.

In addition, in the present embodiment, the cache 130 (semiconductor storage device) is preferentially set as the access destination. This is because, compared to access to the HDD 120, access to the cache 130 has advantages in that fast access to the cache 130 may be achieved, and that a large reduction effect in power consumption may be caused by disabling hard disks of the HDDs 120.

FIG. 7 is a flowchart of command processing. The command processing is performed for processing a command received from the host 2, and is implemented by the CPU 51 executing the processing program mentioned above. As described above, in FIG. 7, in order to avoid confusion, description is given with attention paid only to one RAID group 125. With reference to FIG. 7, the command processing will be described in detail.

Transition from the normal mode to the low-power-consumption mode is performed when the target RAID group 125 is not accessed, for example, for a certain predetermined period of time. In FIG. 7, processing performed at all times is assumed as the command processing since the necessity of determining whether the certain period of time has elapsed since the latest access arises.

The time measurement for determining the elapse of the certain period of time may be performed using a timer installed in the CPU 51. Here, it is assumed that when any one of the HDDs 120 constituting the RAID group 125 is accessed, the timer is reset, for example, the value of the timer is set to zero.

First, the CPU 51 determines whether a command has been received from the host 2 (S11). If the CA 101 has received a command sent from the host 2, the determination of S11 is Y and the processing proceeds to S12. If the CA 101 has not received a command sent from the host 2, the determination of S11 is N and the processing proceeds to S16. Note that the command sent from the host 2 is, more accurately, a command requesting access to the target RAID group 125 from the host 2.

In S12, the CPU 51 performs monitoring I/O detection processing for detecting the monitoring I/O 210 from among commands received from the host 2. After the monitoring I/O detection processing is performed, the processing proceeds to S13.

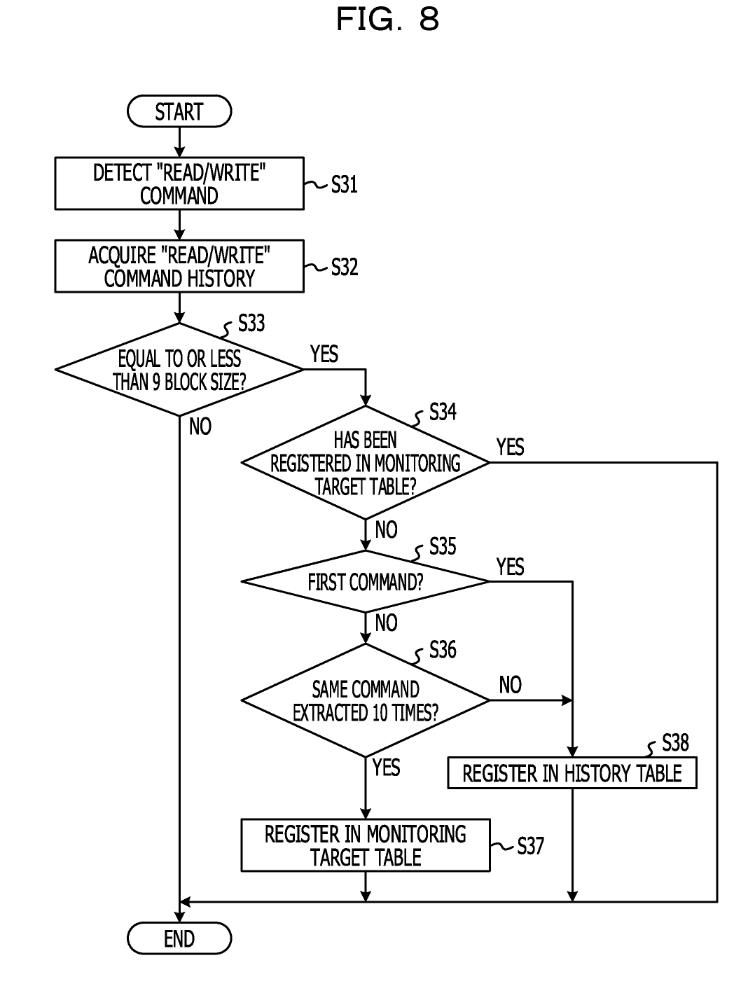

FIG. 8 is a flowchart of the monitoring I/O detection processing. Here, with reference to FIG. 8, the monitoring I/O detection processing will be described in detail.

First, the CPU 51 detects a read command and a write command from among the received commands (S31). The reason why a read command and a write command are detected is that both the read command and the write command are commands that request access to an HDD 120. Here, for the sake of explanatory convenience, it is assumed that only one command is detected. Although not illustrated in particular, if neither a read command nor a write command is detected, the monitoring I/O detection processing terminates here.

If a read command or a write command is detected, the CPU 51 acquires data stored in entries of the history table 105b and the monitoring target table 105c (S32). Next, the CPU 51 determines whether the data length of the detected command is equal to or less than a nine-block size that is set as the threshold (S33). If the detected command is a command that requests reading or writing of data having a length exceeding the nine block size, the determination in S33 is N and the monitoring I/O detection processing terminates here. If the detected command is a command that requests reading or writing of data having a length equal to or less than the nine block size, the determination in S33 is Y and the processing proceeds to S34. The term “block” is a unit region for accessing the HDD 120. The term “block size” is a data length expressed in units of blocks.

In S34, the CPU 51 determines whether the detected command has been registered in the monitoring target table 105c. If an entry in which data having the same command type, address, and data length as the detected command is stored exists in the monitoring target table 105c, the determination in S34 is Y and the monitoring I/O detection processing terminates here. If an entry in which data having the same command type, address, and data length as the detected command is stored does not exist in the monitoring target table 105c, the determination in S34 is N and the processing proceeds to S35.

In S35, the CPU 51 determines whether the detected command is a first command. If the detected command is a command that has not been registered in the history table 105b, the determination in S35 is Y and the processing proceeds to S38. If the detected command is a command that has been registered in the history table 105b, the determination in S35 is N and the processing proceeds to S36.

If the detected command is a command that has not been registered in the history table 105b, this means that an entry in which data having the same command type, address, and data length as the detected command is stored does not exist in the history table 105b. The cycle is excluded from objects of comparison here. This is because, if a user command having the same content as the monitoring I/O 210 is issued, it is difficult to distinguish between the user command and the monitoring I/O 210.

Since such an entry identification is performed, an entry in which data having the same command type, address, and data length as the detected command is stored is already identified at the time when the processing proceeds to S36. The identified entry is referred to as a “target entry” and is distinguished from other entries for the sake of convenience.

In S36, the CPU 51 determines whether the detected command has been extracted ten times. If the cycle calculated from the reception date and time stored in the target entry identified in the history table 105b and the current date and time matches the cycle stored in that entry within a permissible range, and the number of receptions stored in the target entry is “9”, the determination in S36 is Y. Then, the processing proceeds to S37. If the cycle calculated from the reception date and time stored in the target entry and the current date and time does not match the cycle stored in that target entry within the permissible range, or if the number of receptions stored in that target entry is not “9”, the determination in S36 is N. Then, the processing proceeds to S38. The value “9” of the number of receptions is a value obtained assuming that the initial value of the number of receptions is zero.

In S37, the CPU 51 registers the detected command in the monitoring target table 105c. The registration is performed by adding an entry to the monitoring target table 105c and storing data of the command type, address, and data length of the detected command in the added entry. After such registration is performed, the monitoring I/O detection processing terminates.

In S38, the CPU 51 registers the detected command in the history table 105b or updates the entry. When the processing proceeds from S35, for example, an entry is added to the history table 105b, and the reception date and time, respective data of the command type, address, and data length of the detected command, and the number of receptions are stored in the added entry. The CPU 51 does not store the cycle, but stores the number of receptions “0”.

When the processing proceeds from S36, the content of update of the target entry differs depending on the reason why the determination is N. In the case where the determination is N because the cycles do not match within the permissible range, the CPU 51 stores the reception date and time, and stores, for example, a cycle calculated this time as the cycle, and, for example, “1” as the number of receptions. In the case where the determination is N because the number of receptions stored in the target entry is not “9”, the CPU 51 does not change the cycle, and updates the reception date and time and the number of receptions. The number of receptions is updated by incrementing the currently stored value of the number of receptions.

The above monitoring I/O detection processing is performed for a command received from the host 2. Therefore, the monitoring I/O 210 sent from the host 2 is automatically detected and is registered in the monitoring target table 105c. The necessity for the operator to handle addition of an OS issuing the monitoring I/O 210, a change in the specifications of the OS, and so on is low. For this reason, the processing has great convenience for the operator.

Return now to FIG. 7.

In S13 to which the processing proceeds after performing the above monitoring I/O detection processing, the CPU 51 determines whether normal operation is performed, that is, whether the target RAID group 125 is in the normal mode. If the target RAID group 125 is in the normal mode, the determination in S13 is Y and the processing proceeds to S14. If the target RAID group 125 is not in the normal mode, that is, it is in the low-power-consumption mode, the determination in S13 is N and the processing proceeds to S15.

In S14, the CPU 51 performs normal operation processing corresponding to access in the normal mode. After the normal operation processing is performed, the processing returns to S11 mentioned above.

In S15, the CPU 51 performs low-power-consumption operation processing corresponding to access in the low-power-consumption mode. After the low-power-consumption operation processing is performed, the processing returns to S11 mentioned above.

In S16 to which the processing proceeds if the determination in S11 mentioned above is N, the CPU 51 determines whether a predetermined period of time has elapsed since the latest access to the HDD 120. If a period of time measured by the timer mentioned above is equal to or longer than the predetermined period of time, the determination in S16 is Y and the processing proceeds to S17. If the period of time measured by the timer is less than a certain period of time, the determination in S16 is N and the processing returns to S11 mentioned above.

In S17, the CPU 51 determines whether the target RAID group 125 is currently in normal operation. If the target RAID group 125 is in the normal mode, the determination in S17 is Y and the processing proceeds to S18. If the target RAID group 125 is not in the normal mode, the determination in S17 is N and the processing returns to S11 mentioned above.

In S18, the CPU 51 causes the target RAID group 125 to enter the low-power-consumption mode. If the destination of access in response to the monitoring I/O 210 is not set to the HDD 120 of the subgroup 125a of the RAID group 125, operation of all the HDDs 120 constituting that RAID group 125 stops by the transition to the low-power-consumption mode. If the destination of access in response to the monitoring I/O 210 is set to the HDD 120 of the subgroup 125a of the RAID group 125, operation of all the HDDs 120 except the HDDs 120 of the subgroup 125a stops by the transition to the low-power-consumption mode. After transition to such a low-power-consumption mode, the processing returns to S11 mentioned above.

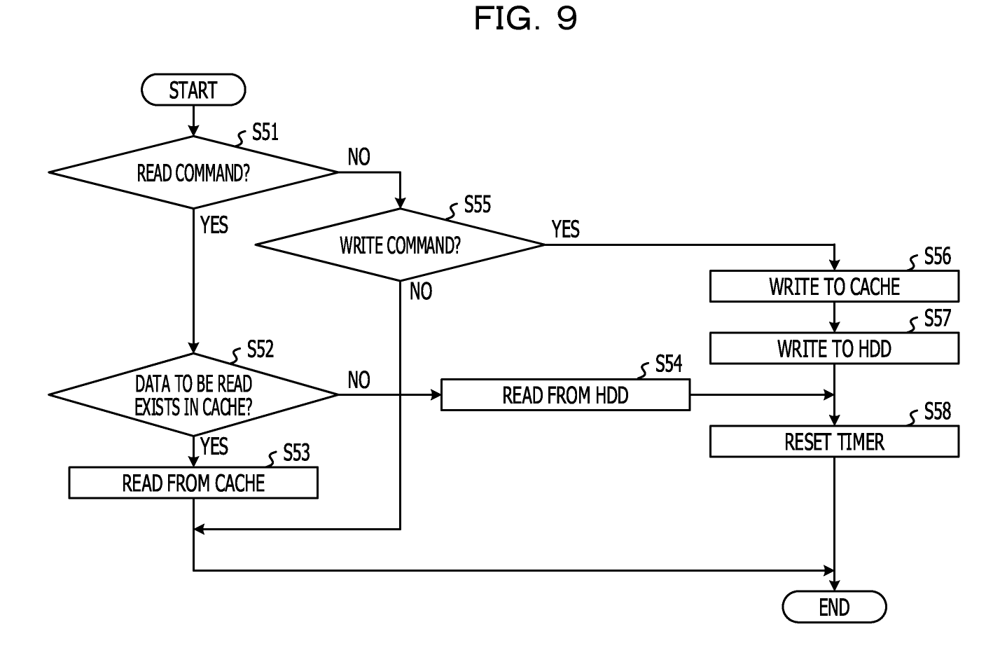

FIG. 9 is a flowchart of the normal operation processing performed in S14 mentioned above. Next, with reference to FIG. 9, the normal operation processing will be described in detail.

Commands other than a command requesting access to an HDD 120 are also included in commands received from the host 2. However, here, in order to avoid confusion, commands received from the host 2 are assumed to be only commands each requesting access to an HDD 120, that is, only read commands and write commands.

First, the CPU 51 determines whether the received command is a read command (S51). If the received command is a read command, the determination in S51 is Y and the processing proceeds to S52. If the received command is a write command, the determination in S51 is N and the processing proceeds to S55.

In S52, the CPU 51 determines whether data requested by the received read command exists in the cache 130. If the requested data exists in the cache 130, the determination in S52 is Y. As a result, the CPU 51 reads the requested data from the cache 130, and sends the read data through the CA 101 to the host 2 (S53). The normal operation processing terminates thereafter. If the requested data does not exist in the cache 130, the determination in S52 is N and the processing proceeds to S54.

In S54, by using the DA 102, the CPU 51 reads data requested by the read command from an HDD 120 identified by the address in that read command, and sends the read data through the CA 101 to the host 2. Next, the CPU 51 resets the timer (S58). Thereafter, the normal operation processing terminates. The reset of the timer in S58 causes the timer to measure a period of time that has elapsed since the latest access to the HDD 120.

In S55 to which the processing proceeds if the determination in S51 mentioned above is N, the CPU 51 determines whether the received command is a write command. If the received command is a write command, the determination in S55 is Y and the processing proceeds to S56. If the received command is not a write command, that is, if the received command is a command other than a read command and a write command, the determination in S55 is N. Therefore, as mentioned above, the normal operation processing terminates.

In S56, the CPU 51 writes data in the write command to the cache 130. Next, by using the DA 102, the CPU 51 writes the data written to the cache 130 to an HDD 120 identified by the address in the write command (S57). Thereafter, the processing proceeds to S58 mentioned above.

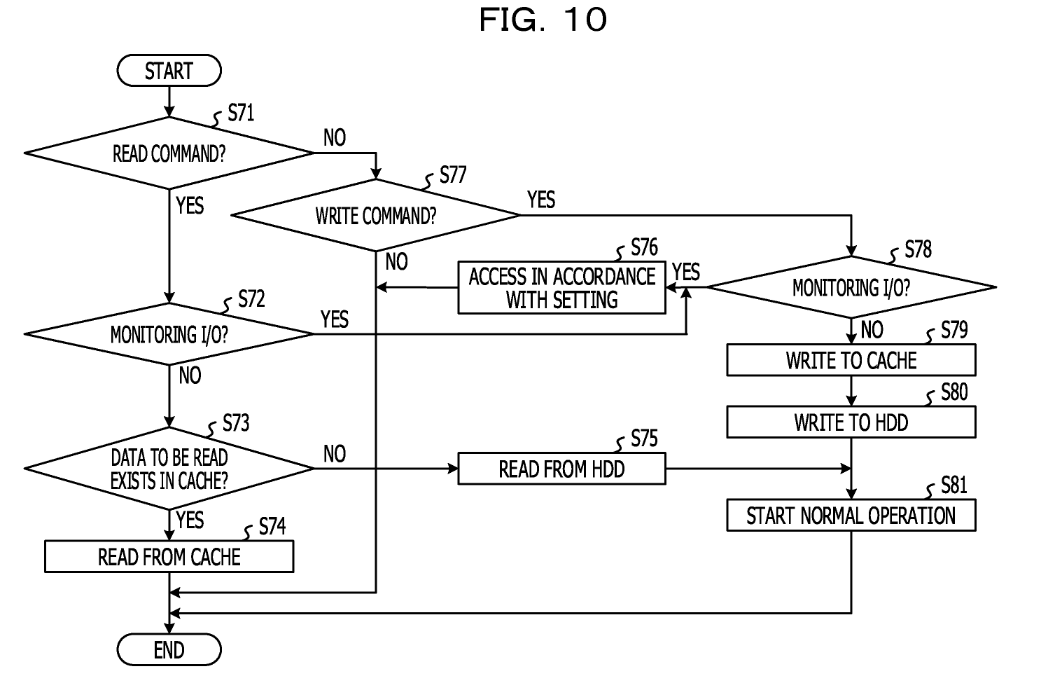

FIG. 10 is a flowchart of the low-power-consumption operation processing performed in S15 in the command processing illustrated in FIG. 7. Finally, with reference to FIG. 10, the low-power-consumption operation processing will be described in detail.

Commands other than the command requesting access to an HDD 120 are also included in commands received from the host 2. However, here, as in the above normal operation processing, commands received from the host 2 are assumed to be only commands each requesting access to an HDD 120, that is, only read commands and write commands.

First, the CPU 51 determines whether the received command is a read command (S71). If the received command is a read command, the determination in S71 is Y and the processing proceeds to S72. If the received command is a write command, the determination in S71 is N and the processing proceeds to S77.

In S72, referring to the monitoring target table 105c, the CPU 51 determines whether the received read command is a monitoring I/O 210. If an entry having the same command type, address, and data length as the received read command exists in the monitoring target table 105c, the determination in S72 is Y and the processing proceeds to S76. If an entry having the same command type, address, and data length as the received read command does not exist in the monitoring target table 105c, the determination in S72 is N and the processing proceeds to S73.

In S73, the CPU 51 determines whether data requested by the received read command exists in the cache 130. If the requested data exists in the cache 130, the determination in S73 is Y. As a result, the CPU 51 reads the requested data from the cache 130, and sends the read data through the CA 101 to the host 2 (S74). The low-power-consumption operation processing terminates thereafter. If the requested data does not exist in the cache 130, the determination in S73 is N and the processing proceeds to S75.

In S75, by using the DA 102, the CPU 51 reads the data requested by the read command from an HDD 120 identified by the address in that read command, and sends the read data through the CA 101 to the host 2. Next, the CPU 51 starts the normal operation, that is, the CPU 51 causes the RAID group 125 to enter the normal mode (S81). Thereafter, the low-power-consumption operation processing terminates. Operation of all the HDDs 120 constituting that RAID group 125 starts by the transition to the normal mode.

If the above determination in S72 is Y, access in response to the monitoring I/O 210 is performed to the access destination set by performing the access destination determination processing illustrated in FIG. 6 (S76). At this point, since the monitoring I/O 210 is a read command, the CPU 51 sends data read by the access to the host 2 through the CA 101. Thereafter, the low-power-consumption operation processing terminates.

If the above determination in S71 is N, the CPU 51 determines whether the received command is a write command (S77). If the received command is a write command, the determination in S77 is Y and the processing proceeds to S78. If the received command is not a write command, that is, if the received command is a command other than a read command and a write command, the determination in S77 is N. Therefore, as mentioned above, the low-power-consumption operation processing terminates.

In S78, referring to the monitoring target table 105c, the CPU 51 determines whether the received write command is a monitoring I/O 210. If an entry having the same command type, address, and data length as the received write command exists in the monitoring target table 105c, the determination in S78 is Y and the processing proceeds to S76. If an entry having the same command type, address, and data length as the received write command does not exist in the monitoring target table 105c, the determination in S78 is N and the processing proceeds to S79.

In S79, the CPU 51 writes data in the write command to the cache 130. Next, by using the DA 102, the CPU 51 writes the data written to the cache 130 to an HDD 120 identified by the address in the write command (S80). Thereafter, the processing proceeds to S81 mentioned above.

If the determination in S78 is Y, the CPU 51 performs access for writing data in the write command, which is a monitoring I/O 210, to the access destination set by performing the access destination determination processing illustrated in FIG. 6 (S76). Thereafter, the low-power-consumption operation processing terminates.

It is to be noted that although, in the present embodiment, one example based on the present disclosure is applied to the CM 10 installed in the disk array device 1, a storage control device to which one example based on the present disclosure is applicable may be installed in a device different from the disk array device 1. The storage control device may be installed, for example, in an information processing device (computer) having a storage mounted therein, such as a personal computer or a server. For example, in the information processing device having a configuration in which the installed CPU accesses a storage through a controller, one example based on the present disclosure may be applied to the controller. The storage is not limited to an HDD 120. For example, the storage may be one that rotates a disk of a different type from a hard disk (magnetic disk).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the present embodiments of the present invention have been described in detail, it should be understood that the various changes, substitutions, and alterations could be made hereto without departing from the spirit and scope of the invention.

What is claimed is:

1. A storage control device comprising:
a processor configured to
receive commands requesting access to a first storage,
detect, among the received commands, a monitoring command requesting access for monitoring to the first storage, and
restrict access to the first storage in response to the detected monitoring command.

2. The storage control device according to claim 1, wherein
the processor is configured to
set a first device to be accessed, and
restrict access to the first storage in response to the monitoring command by performing access to the first device in response to the monitoring command.

3. The storage control device according to claim 2, wherein
the processor is configured to
set a second storage other than the first storage as the first device.

4. The storage control device according to claim 1, wherein
the processor is configured to
identify the monitoring command among the received commands, based on types of the received commands, addresses to which the received commands request to access, and data lengths of data requested by the received commands, and
determine, using a result of the identification, whether a received command is a monitoring command.

5. The storage control device according to claim 4, wherein
the processor is configured to
extract first commands, the first commands being of a same type, the first commands requesting to access a same address, the first commands requesting to access data of a same data length, and
identify the monitoring command by extracting second commands from among the first commands, a reception interval of the second commands being assumed to be fixed.

6. The storage control device according to claim 1, wherein
the storage control device is installed in a disk array device including a plurality of hard disk drives, the first storage being one of the plurality of hard disk drives.

7. An access control method comprising:
receiving, by a computer, commands requesting access to a first storage;
detecting, among the received commands, a monitoring command requesting access for monitoring to the first storage; and
restricting access to the first storage in response to the detected monitoring command.

8. A computer-readable recording medium having stored therein a program for causing a computer to execute a process, the process comprising:
receiving commands requesting access to a first storage;
detecting, among the received commands, a monitoring command requesting access for monitoring to the first storage; and
restricting access to the first storage in response to the detected monitoring command.
